(19) United States
(12) Patent Application Publication
(10) Pub. No.: US 2008/0084490 A1
(43) Pub. Date: Apr. 10, 2008

(54) Solid-state imaging device and electronic device

(75) Inventor: Atsushi Masagaki, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 11/900,846

(22) Filed: Sep. 13, 2007

(30) Foreign Application Priority Data
Oct. 5, 2006 (JP) P2006-274213

(51) Int. Cl. H04N 5/335

(52) U.S. Cl. 348/308; 348/E05.091

(57) ABSTRACT

A solid-state imaging device is provided. The solid-state imaging device includes an imaging area including a plurality of pixels arrayed in a two-dimensional matrix. Each of the pixels includes a photodiode having a first conductivity-type electric charge accumulation area and a transistor for reading electric charges obtained at the photodiode; and an independent first conductivity-type region provided to at least part of the plurality of pixels and isolated from the photodiode and the transistor. The independent first conductivity-type region is provided continuously between adjacent pixels and nonuniformly within each pixel.

### CROSS REFERENCES TO RELATED APPLICATIONS

The present invention contains subject matter related to Japanese Patent Application JP 2006-274213 filed in the Japanese Patent Office on Oct. 5, 2006, the entire contents of which being incorporated herein by reference.

### BACKGROUND OF THE INVENTION

1. Field of the Invention

The present invention relates to a solid-state imaging device and an electronic device including the solid-state imaging device.

2. Description of the Related Art

Solid-state imaging devices are known in which each of a plurality of pixels arrayed in a two-dimensional matrix includes a photoelectric converting portion having a photodiode.

A CMOS (complementary metal-oxide semiconductor) solid-state imaging device is known as one of such solid-state imaging devices. The CMOS solid-state imaging device includes an amplifying circuit portion having MOS (metal-oxide semiconductor) transistors to detect electrons obtained at the photoelectric converting portions as signals and is manufactured by a CMOS process. The CMOS solid-state imaging device has a number of merits such as being driven at a low voltage with low power consumption and being integrated as one chip with peripheral circuits and starts being mounted to electronic devices such as portable electronic devices.

FIG. 1 of the accompanying drawings is a diagram showing an arrangement of a solid-state imaging device according to related art.

As shown in FIG. 1, a solid-state imaging device 101 according to the related art includes: a pixel array 102 in which a plurality of pixels 101a are arrayed in a two-dimensional matrix; a vertical driving circuit 103; a column signal processing circuit 104; a horizontal driving circuit 105; a horizontal signal line 106; an output circuit 107; and a control circuit 108.

In the solid-state imaging device 101, the pixel array 102 includes the plurality of pixels 101a arrayed in a two-dimensional matrix in which row control lines are provided for respective pixel rows in the lateral direction (right and left direction) in FIG. 1 and vertical signal lines 109 are provided for respective pixel column in the longitudinal direction (upper and lower direction) in FIG. 1.

In the solid-state imaging device 101 having the above-mentioned arrangement, the vertical driving circuit 103, formed of a shift register or other devices, selectively scans pixel 101a of the pixel array 102 one-row at a time sequentially to supply a necessary control pulse to each pixel of the selected row through the aforementioned row control line.

A signal output from each pixel of the selected row is supplied through the vertical signal line 109 to the column signal processing circuit 104. The column signal processing circuit 104 receives a signal output from the pixels 101a of one row for respective pixel columns. Subsequently, the column signal processing circuit 104 effects processing such as CDS (correlated double sampling) to remove a fixed pattern noise inherent in the pixel 101a and signal amplification on the received signal.

The thus processed signal is output as a pixel signal from each of the column signal processing circuits 104. Specifically, the horizontal driving circuit 105 formed of, for example, a shift register sequentially selects each of the column signal processing circuits 104 to output processed signals as horizontal scanning pulse φH1 to φHn in that order.

In addition, the output circuit 107 effects various kinds of signal processing on the signals sequentially supplied through the horizontal signal line 106 from each of the column signal processing circuits 104. Buffering, for example, may be effected as specific signal processing at the output circuit 107, and black level adjustment, correction of signal variations in columns, signal amplification, color-related processing and the like may be performed as pre-processing for buffering.

Further, the control circuit 108 receives data indicating, for example, an operation mode of the solid-state imaging device 101 from the outside and outputs data including information on the solid-state imaging device 101 to the outside. Also, the control circuit 108 generates reference clock signals, control signals and the like for the operation at the vertical driving circuit 103, column signal processing circuit 104 and horizontal driving circuit 105. Those signals are generated based on a vertical synchronizing signal, horizontal synchronizing signal, master clock and the like and supplied to the vertical driving circuit 103, column signal processing circuit 104, horizontal driving circuit 105 and the like.

FIG. 2 shows a three-transistor type circuit arrangement, for example, used for the pixel 101a.

As shown in FIG. 2, in the circuit arrangement, the cathode (n region) of a photodiode (PD) is connected to the gate of an amplifying transistor Tr3 through a transfer transistor Tr1. A node electrically connected to the gate of the amplifying transistor Tr3 is referred to as a “floating diffusion (FD)”. The transfer transistor Tr1 is connected between the photodiode (PD) and the floating diffusion (FD) and is turned on with a transfer pulse φTRG being supplied to the gate thereof through a transfer line 111, thereby transferring signal charges photo-electrically converted by the photodiode (PD) to the floating diffusion (FD).

A reset transistor Tr2 is connected at its drain to a pixel power supply Vdd1 and the source thereof is connected to the floating diffusion (FD). The reset transistor Tr2 is turned on with a reset pulse φRST being supplied to the gate thereof through a reset line 112a and resets the floating diffusion (FD) by discharging electric charges from the floating diffusion (FD) to the pixel power supply Vdd1 prior to transferring signal charges from the photodiode (PD) to the floating diffusion (FD).

The amplifying transistor Tr3 is connected at its gate to the floating diffusion (FD) and the drain thereof is connected to a pixel power supply Vdd2, the source thereof being connected to a vertical signal line 113. The amplifying transistor Tr3 outputs electric potential obtained from the floating diffusion (FD) after being reset by the reset transistor Tr2 to the vertical signal line 113 as a reset level. Further, the amplifying transistor Tr3 outputs electric potential obtained from the floating diffusion (FD) after signal charges being transferred by the transfer transistor Tr1 to the vertical signal line 113 as a signal level.

The drain of the amplifying transistor Tr3 is fluctuated by influences caused by the pixel power supply Vdd1 being switched between a high level and a low level as the pixel is driven.

FIG. 3, on the other hand, shows a four-transistor type circuit arrangement, for example, used as another circuit arrangement for use with the pixel 101a.

As shown in FIG. 3, the circuit arrangement includes four transistors Tr1 to Tr4 in addition to the photoelectric converting device, for example, the photodiode (PD). Here, the transistors Tr1 to Tr4 are formed as N-channel MOS transistors, for example.

The photodiode (PD) photo-electrically converts received light to photocharge (herein, electrons) an amount of which corresponds to an amount of received light. The cathode (N-type region) of the photodiode (PD) is connected to the gate of the amplifying transistor Tr3 through the transfer transistor Tr1. A node electrically connected to the gate of the amplifying transistor Tr3 becomes the floating diffusion (FD).

Wiring in the lateral direction, that is, a transfer line 114, a reset line 115 and a selection line 116 are common to pixels in a row and controlled by a vertical driving circuit. However, a p-type well wiring 117 used to fix p-type well electric potential of the pixel 101a is fixed to the ground potential.

Also, in such circuit arrangement, the transfer transistor Tr1 is connected between the cathode of the photodiode (PD) and the floating diffusion (FD) and turned on by a transfer pulse φTRG supplied to the gate thereof through the transfer line 114, thereby transferring photocharges photo-electrically converted at the photodiode (PD) to the floating diffusion (FD).

The reset transistor Tr2 is connected at its drain to the pixel power supply Vdd and the source thereof is connected to the floating diffusion (FD). The reset transistor Tr2 is turned on by a reset pulse φRST supplied to its gate through the reset line 115 and resets the floating diffusion (FD) by discharging electric charges from the floating diffusion (FD) to the pixel power supply Vdd prior to the transfer of signal charges from the photodiode (PD) to the floating diffusion (FD). The amplifying transistor Tr3 is connected at its gate to the floating diffusion (FD) and the drain thereof is connected to the pixel power supply Vdd. The amplifying transistor Tr3 outputs electric potential obtained from the floating diffusion (FD) as a reset level after the reset transistor Tr2 has reset the floating diffusion (FD). Further, the amplifying transistor Tr3 outputs electric potential obtained from the floating diffusion (FD) as a signal level after the transfer transistor Tr1 has transferred signal charges.

The selection transistor Tr4 is connected at its drain to the source of the amplifying transistor Tr3 and the source thereof is connected to a vertical signal line 118. The selection transistor Tr4 is turned on by a selection pulse φSEL supplied to its gate through the selection line 116, thereby setting the pixel 101a to the selected state so that a signal output from the amplifying transistor Tr3 is supplied to the vertical signal line 118.

FIG. 4A is a schematic top view showing the arrangement of the pixel 101a of the solid-state imaging device 101 of related art and FIG. 4B is a cross-sectional view along the line A-A in, FIG. 4A. Here, the amplifying circuit portion includes an arrangement corresponding to the aforementioned 4-transistor type circuit arrangement.

As shown in FIG. 4A, pixel 101a of related art includes a photoelectric converting portion (denoted by x₁) having a photodiode including a charge accumulation region and an amplifying circuit portion (denoted by x₂) including transistors (denoted by Tr1 to Tr4) to read electric charges obtained at the photodiode. The photoelectric converting portion photo-electrically converts incident light and accumulates therein generated electric charges. The amplifying circuit portion converts and amplifies electrons accumulated in the charge accumulation region in response to the aforementioned selection of a pixel (see Japanese Unexamined Patent Application Publication No. 2006-120804, for example).

As shown in FIG. 4B, the photoelectric converting portion has an arrangement in which a photodiode (photoelectric converting device) 125 is provided on one major surface (upper surface in this example) of a semiconductor substrate (for example, silicon substrate). The photodiode 125 includes a P-type impurity region 123 with a high concentration and an N-type impurity region 124. The semiconductor substrate is formed of a first conductivity type (P-type) with a low concentration or a second conductivity type (N-type) with an optional concentration. The photodiode 125 is a buried photodiode forming a main portion of the photoelectric converting portion and the highly-concentrated P-type impurity region 123 formed on the surface thereof may reduce a dark current. On the other hand, the amplifying circuit portion includes an N-type impurity region 127 with a high concentration as the drain of the transistor Tr1 at the position facing the transfer transistor Tr1 the source of which is the aforementioned photodiode 125 across a gate 126. On the outside of the transfer transistor Tr1, there are formed element isolators 128a and 128b in contact with the photodiode 125 and the N-type impurity region 127 such that the isolators are exposed to the major surface and have a depth deeper than the P-type impurity region 123 and the N-type impurity region 127. STI (shallow trench isolation), LOCOS (local oxidation of silicon) or the like may be employed for these element isolators 128a and 128b.

Electronic shutter operation is carried out in photodiodes in the whole pixels at a time, which is one of characteristics that desirably be improved in a CMOS solid-state imaging device. In a solid-state imaging device having the pixel arrangement according to related art, the shutter operation of photodiodes of the whole pixels is carried out at a time such that the transfer transistor (Tr1) and the reset transistor (Tr2) are turned on so that voltages of the photodiode and the floating diffusion are fluctuated to the power supply voltage Vdd. As long as the CMOS solid-state imaging device has the above-mentioned related-art arrangement, the floating diffusion and the photodiode are always reset at the same time. Therefore, it may be difficult to individually fluctuate (select) voltages of the floating diffusion and the photodiode.

However, it is not preferable to fluctuate electric potential of the semiconductor substrate 122 in order to improve the electronic shutter operation characteristic. Since the semiconductor substrate 122 of the CMOS solid-state imaging device is provided as a substrate common to other peripheral circuits and devices, if electric potential of the semiconductor substrate 122 is changed, there is then a risk that unfavorable influence may be exerted upon the peripheral circuits and devices. Also, there may be an arrangement in which separate wiring is provided to enable the voltages of the floating diffusion and the photodiode to separately change in order to improve the electronic shutter operation characteristic. However, such arrangement may cause an aperture ratio of the photodiode to be lowered, which therefore is not preferable. Separately provided wiring may cause the area of the amplifying circuit portion to increase.

While a CMOS solid-state imaging device has several characteristics expected to be improved, there are restrictions for the CMOS solid-state imaging device in view of improving its characteristics, as typically represented by the above-mentioned example.

### SUMMARY OF THE INVENTION

It is desirable to provide a solid-state imaging device capable of improving characteristics without depending on fluctuations of electric potential of a substrate while controlling an aperture ratio not to be lowered and an electronic device including the solid-state imaging device.

According to an embodiment of the present invention, there is provided a solid-state imaging device including an imaging area having a plurality of pixels arrayed in a two-dimensional matrix. Each of the pixels includes a photodiode having a first conductivity-type electric charge accumulation area and a transistor for reading electric charges obtained at the photodiode. At least part of the plurality of pixels include an independent first conductivity-type region isolated from the photodiode and the transistor, in which the independent first conductivity-type region is provided continuously between adjacent pixels and nonuniformly within each pixel. According to the solid-state imaging device, independent electric potential may be given to the independent first conductivity-type region.

According to another embodiment of the present invention, there is provided an electronic device including a solid-state imaging device, the solid-state imaging device including an imaging area having a plurality of pixels arrayed in a two-dimensional matrix. Each of the pixels includes a photodiode having a first conductivity-type electric charge accumulation area and a transistor for reading electric charges obtained at the photodiode. At least part of the plurality of pixels include an independent first conductivity-type region isolated from the photodiode and the transistor, in which the independent first conductivity-type region is provided continuously between adjacent pixels and nonuniformly within each pixel. According to the electronic device, independent electric potential may be given to the independent first conductivity-type region.

According to an embodiment of a solid-state imaging device of the present invention, an independent first conductivity-type region is formed continuously between adjacent pixels and nonuniformly within each pixel. Accordingly, it becomes possible to improve desired characteristics by selecting electric potential given to the independent first conductivity-type region without depending on fluctuation of substrate potential while controlling an aperture ratio not to be lowered.

According to an embodiment of an electronic device of the present invention, a solid-state imaging device which is a main portion of the electronic device includes an independent first conductivity-type region formed continuously between adjacent pixels and nonuniformly within each pixel. Accordingly, it becomes possible to improve desired characteristics by selecting electric potential given to the independent first conductivity-type region without depending on fluctuation of substrate potential while controlling an aperture ratio not to be lowered.

### BRIEF DESCRIPTION OF THE DRAWINGS

FIG. 1 is a schematic diagram for describing a solid-state imaging device.

FIG. 2 is a circuit diagram for describing a solid-state imaging device.

FIG. 3 is a circuit diagram for describing a solid-state imaging device.

FIG. 4A is a schematic top view showing an arrangement of a pixel of a solid-state imaging device according to related art; and FIG. 4B is a cross-sectional view along the line A-A shown in FIG. 4A.

FIG. 5A is a schematic top view showing an example of an arrangement of a pixel of a solid-state imaging device being a main portion of an electronic device according to an embodiment of the present invention; FIG. 5B is a cross-sectional view along the line A′-A′ shown in FIG. 5A, representing a first example of the arrangement; and FIG. 5C is a cross-sectional view along the line A′-A′ shown in FIG. 5A, representing a second example of the arrangement.

FIG. 6A is a perspective view showing an example of an arrangement of a solid-state imaging device being a main portion of an electronic device according to an embodiment of the present invention; and FIG. 6B is an enlarged perspective view for describing an electrode.

FIGS. 7A, 7B and 7C are process diagrams respectively showing an example of a method of manufacturing a solid-state imaging device being a main portion of an electronic device according to an embodiment of the present invention.

### DESCRIPTION OF THE PREFERRED EMBODIMENTS

Embodiments of the present invention will be described below with reference to the drawings.

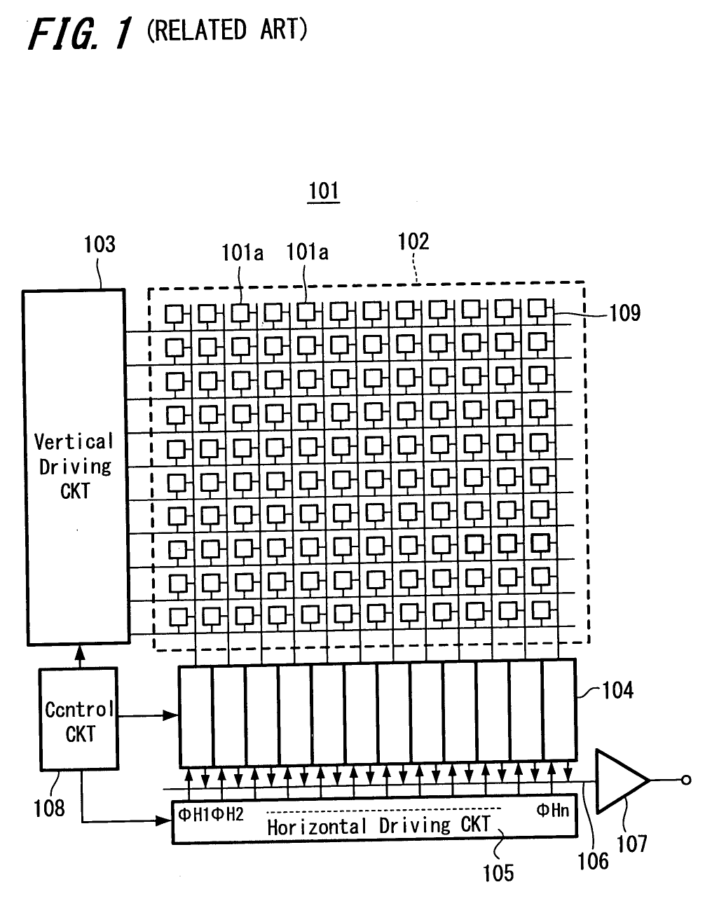

In the embodiments of the present invention, a CMOS solid-state imaging device that is a main portion of an electronic device such as a camera and a mobile phone unit will be described as an example of a solid-state imaging device. It should be noted that an overall arrangement of a CMOS solid-state imaging device, which will be described in the embodiments of the invention, is similar to that of the solid-state imaging device 101 shown in FIG. 1.

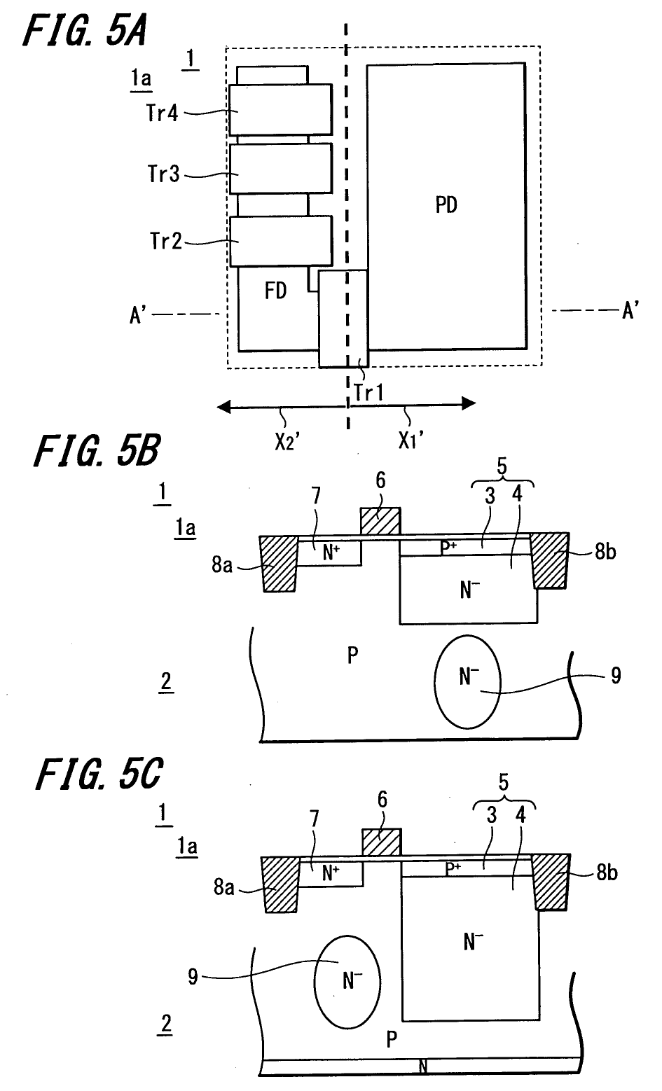

FIGS. 5A to 5C are diagrams showing a solid-state imaging device according to an embodiment of the present invention that is a main portion of an electronic device according to an embodiment of the present invention. FIG. 5A is a schematic top view showing an example of an arrangement of a pixel of the solid-state imaging device. FIG. 5B is a schematic cross-sectional view, showing a first example of the arrangement; and FIG. 5C is a cross-sectional view showing a second example of the arrangement. As shown in FIG. 5A, a solid-state imaging device 1 according to an embodiment of the present invention includes a pixel 1a formed of a photoelectric converting portion (shown by reference numeral x₁′ in FIG. 5A) and an amplifying circuit portion (shown by reference numeral x₂′). The photoelectric converting portion includes a photodiode (photoelectric converting device) having a charge accumulation region. The amplifying circuit portion includes transistors (denoted by reference numerals Tr1 to Tr4) to read electric charges obtained at the photodiode.

The photoelectric converting portion has an arrangement in which a photodiode 5 is provided on one major surface (upper surface in this embodiment) of a semiconductor substrate (for example, silicon substrate). The photodiode 5 includes a P-type impurity region 3 with a high concentration and an N-type impurity region 4. The semiconductor substrate is formed of a first conductivity type (N-type) with an optional impurity concentration or a second conductivity type (P-type) with a low concentration. The photodiode 5 is a buried photodiode forming a main portion of the photoelectric converting portion and photo-electrically converts incident light. Generated electric charges are accumulated in the charge accumulation region 4. Further, the highly-concentrated P-type impurity region 3 formed on the surface may reduce a dark current.

On the other hand, the amplifying circuit portion includes an N-type impurity region 7 with a high concentration as the drain of the transistor Tr1 at the position facing the transfer transistor Tr1 the source of which is the aforementioned photodiode 5 across a gate 6. Electrons accumulated in the charge accumulation region 4 are converted and amplified in response to selection of the aforementioned pixel.

Further, on the outside of the transfer transistor Tr1, there are formed element isolators 8a and 8b in contact with the photodiode 5 and the N-type impurity region 7 such that the isolators are exposed to the major surface and have a depth deeper than the P-type impurity region 3 and the N-type impurity region 7. STI (shallow trench isolation), LOCOS (local oxidation of silicon) or the like may be employed for these element isolators 8a and 8b.

Further, the solid-state imaging device according to the embodiment of the present invention includes an independent first conductivity-type region (independent N-type region in this embodiment) 9 isolated from the photodiode and the transistor.

Arrangement and shape of the independent N-type region 9 will be described below with reference to first and second examples of arrangement.

FIG. 5B is a schematic cross-sectional view of the pixel 1a and which shows an arrangement and shape of the independent N-type region 9 as the first example of the arrangement of the solid-state imaging device according to an embodiment of the present invention.

In the first example of the arrangement, the independent N-type region 9 is provided as a region having the position different from that of the photodiode 5 in the depth direction perpendicular to a two-dimensional plane in which a plurality of pixels 1a are arrayed in the form of a matrix. More specifically, the independent N-type region 9 in the first example of the arrangement is provided at a position deeper than that of the photodiode 5. Further, in the first example of the arrangement, the independent N-type region 9 is isolated from any of the N-type impurity region 4 forming the photodiode 5 and the N-type impurity region 7 forming the transistor through a P-type region of the semiconductor substrate 2.

FIG. 5C is a schematic cross-sectional view of the pixel 1a and which shows an arrangement and shape of the independent N-type region 9 as the second example of the arrangement of the solid-state imaging device according to an embodiment of the present invention. In the second example of the arrangement, the independent N-type region 9 is provided as a region having a similar depth to that of the photodiode 5 in the depth direction perpendicular to a two-dimensional plane in which a plurality of pixels 1a are arrayed in the form of a matrix. More specifically, the independent N-type region 9 in the second example of the arrangement is provided at the side of the photodiode 5.

In addition, in the second example of the arrangement, the independent N-type region 9 is isolated from any of the N-type impurity region 4 forming the photodiode and the N-type impurity region 7 forming the transistor through the P-type region of the semiconductor substrate 2.

As shown in the first and second examples of arrangement, the independent N-type region 9 may not be provided uniformly (over the whole area) within each pixel 1a in the solid-state imaging device according to the embodiment of the invention. Specifically, the independent N-type region 9 is nonuniformly provided within each pixel 1a, for example, occupying part of a width thereof without extending over the whole area.

According to the arrangement including the above-mentioned independent N-type region 9, it becomes possible to set independent electric potential separately from the N-type impurity region 7 that is the drain of the transistor and the N-type impurity region that forms the photodiode 5. Accordingly, it becomes possible for the solid-state imaging device according to the embodiment of the present invention to have desired characteristics improved in response to electric potential given to the independent N-type region 9 without depending on substrate potential.

A specific example of the characteristics improved is a characteristic of electronic shutter operation. According to the solid-state imaging device of the embodiment of the present invention including the independent N-type region 9, an impurity concentration of the independent N-type region 9 and an impurity concentration of the N-type impurity region 7 are selected beforehand. Specifically, those impurity concentrations are selected so that a potential barrier between the photodiode 5 and the independent N-type region 9 may be lowered to a certain level with application of a power supply voltage Vdd which will be described later. Electric potential of the independent N-type region 9 is set to 0V beforehand upon ordinary state (when the element isolators 8a and 8b are formed of P-type impurity regions, electric potential of the independent N-type region 9 is set to 0V similarly to the P-type impurity regions). Then, only when it is intended to discharge electrons from the photodiode 5 by the shutter operation, electrons are discharged from the photodiode 5 to the independent N-type region 9 with the low potential barrier with application of the power supply voltage Vdd. As a result, the shutter operation can be performed regardless of the electric potential of the floating diffusion (FD). It should be noted that other characteristics such as construction of overflow path and suppression of blooming can be improved by selecting the position of the independent N-type region 9 and the impurity concentration as later described in the second example of the arrangement.

Also, an overflow path that allows electrons excessively accumulated in the photodiode 5 to be discharged from the photodiode 5 may be obtained as one of the characteristics particularly improved by the pixel arrangement that has been described so far with reference to the aforementioned second example of the arrangement. Specifically, if the potential barrier between the photodiode 5 and the independent N-type region 9 has been lowered by retaining the electric potential of the independent N-type region 9 at a constant level and when excess electrons are accumulated in the photodiode 5, the independent N-type region 9 may function as the overflow path.

Since such overflow path is formed, electrons excessively generated in the photodiode 5 can be moved with priority (with stability) into the independent N-type region 9, which becomes the three-dimensional overflow path. Thus, it is possible to avoid a problem in which electrons excessively generated in the photodiode 5 are caused to move randomly both in the vertical direction (depth direction) and the lateral direction (horizontal plane direction in which pixels are arrayed) to deteriorate image quality, which is a problem in a related-art CMOS solid-state imaging device. Further, since the overflow path is formed, the solid-state imaging device may not depend on the arrangement of moving electrons to the floating diffusion through the N-type impurity region 7, so that the floating diffusion may not need to be reset.

Also, according to the aforementioned solid-state imaging device of the embodiment of the present invention, a vertical overflow drain, which may typically need a relatively expensive N-type substrate (or N-type epitaxial growth layer), can be obtained readily at a low cost only by adding one ion implantation process.

Also, suppression of blooming can be one of the other characteristics particularly improved by the pixel arrangement that has been so far described in the second example of the arrangement. Specifically, a potential well is formed on the independent N-type region 9 by selecting an impurity concentration and electric potential of the independent N-type region 9. As a result, electrons which start to move into the photodiode 5 from the outside (other pixel) to cause blooming can be absorbed by the independent N-type region 9.

In addition, according to the pixel arrangement described in the second example of the arrangement, the solid-state imaging device may have more features as compared with the pixel arrangement described in the first example of the arrangement.

First, since the independent N-type region 9 can be formed at a relatively shallow position, it may become easy to form the independent N-type region 9. Further, a dead space produced due to a difference between a depth (4 μm to 5 μm) of the N-type impurity region 4 of the photoelectric converting portion and a depth (1 μm) of the N-type impurity region 7 of the amplifying circuit portion in the related-art solid-state imaging device can be utilized for the shutter operation, overflow path and suppressing blooming. Further, it is not preferable to apply a high voltage to the CMOS solid-state imaging device from a structure standpoint. Accordingly, the independent N-type region 9 should preferably be provided at a position in which low voltage drive is enabled by making effective use of a difference between potential barriers of the N-type impurity region 7 with the high impurity concentration and the photodiode 5.

It should be noted that, in the solid-state imaging device according to the embodiment of the present invention including the first and second examples of the arrangements, an impurity concentration of the independent N-type region 9 should be selected based on a relationship between it and the N-type impurity region 7 and characteristics to be improved. For example, when the impurity concentration of the N-type impurity region 7 is in the order of 1×10¹⁶/cm³, the impurity concentration of the independent N-type region 9 may be in the order of 1×10¹⁵/cm³ to improve electronic shutter operation characteristics; in the order of 1×10¹²/cm³ to 1×10¹³/cm³ to suppress blooming from a standpoint of potential balance; and in the order of 1×10¹²/cm³ to 1×10¹³/cm³ to form an overflow path. It should be noted that other impurity concentrations than these numerical values (these ranges) can be selected. For example, impurity concentrations equal to or lower than that of the N-type impurity region 7 of the transistor and impurity concentrations equal to or higher than that of the N-type impurity region 4 of the photodiode 5 may be particularly suitable as the impurity concentration of the independent N-type region 9

As described above, by appropriately selecting impurity concentration of the independent N-type region 9, it is possible to improve two or more characteristics such as the above-mentioned electronic shutter operation characteristics, overflow path and suppression of blooming.

In the solid-state imaging device 1 according to the embodiment of the present invention, the independent N-type regions 9 should preferably be coupled (connected) to electrodes that supply electric potential to the independent N-type regions 9 on the outside of a plurality of pixels 1a (pixel arrays) arrayed in a two-dimensional matrix. If the independent N-type regions 9 are coupled to the electrodes on the outside of the pixel arrays, it is possible to avoid part of pixels from being sacrificed for the electrode arrangement.

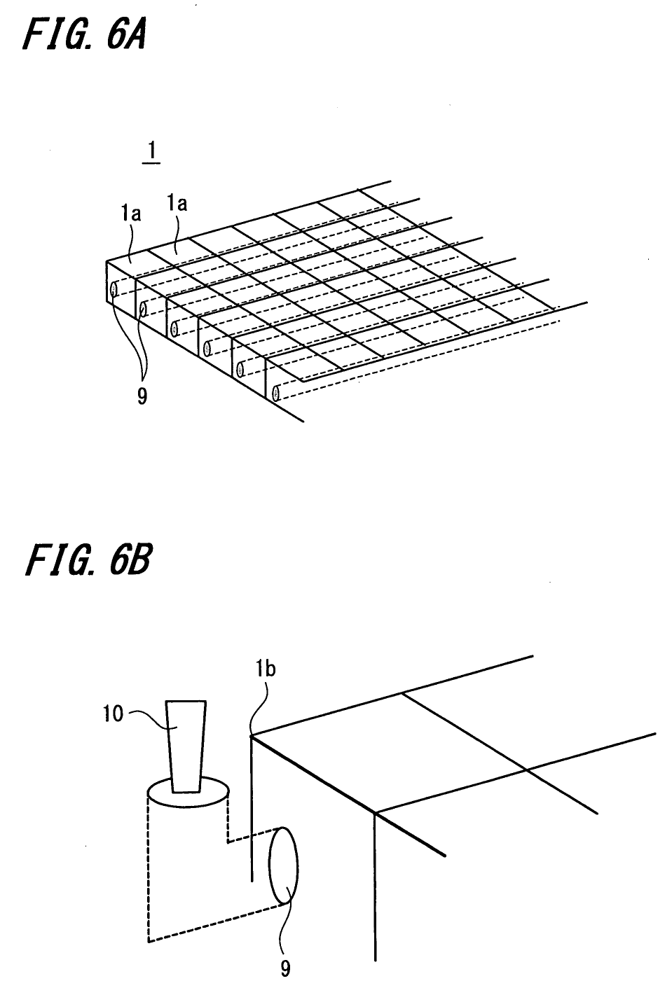

FIGS. 6A and 6B show an arrangement in which the independent N-type regions 9 and the electrodes are coupled and arranged. It should be noted that FIGS. 6A and 6B schematically show the independent N-type regions 9 alone, in which elements and parts such as the photodiode 5 illustrated in FIGS. 5B and 5C are not illustrated with respect to the cross-section of each pixel 1a.

In the solid-state imaging device 1 according to the embodiment of the present invention, the independent N-type regions 9 are provided as the regions continuing between adjacent pixels in the first direction (for example, in the vertical direction in the pixel array) within the two-dimensional plane in which the pixels 1a are arrayed in the form of a matrix. Further, the independent N-type regions 9 are provided as the regions not continuing between the pixels in the second direction (for example, in the horizontal direction in the pixel array). Specifically, the independent N-type regions 9 are formed like the blinds in the condition that respective pixels are connected to each other like a pipeline only in the first direction.

The pipeline-like independent N-type regions 9 formed as the blinds are coupled to an electrode (upper wiring layer) 10 made of, for example, aluminum (Al) at a pixel end 1b through an N-type impurity region continuously formed up to the height substantially equal to that of the pixel array as shown in FIG. 6B, where the pixel array is coupled on the outside of the pixel array.

According to the arrangement, while a plurality of pixels extended in the second direction are being distinguished, a plurality of pixels extended in the first direction can be operated in a predetermined manner at a time. It should be noted that specific operations in each pixel are similar to those of the first example of the arrangement and the second example of the arrangement and therefore need not be described.

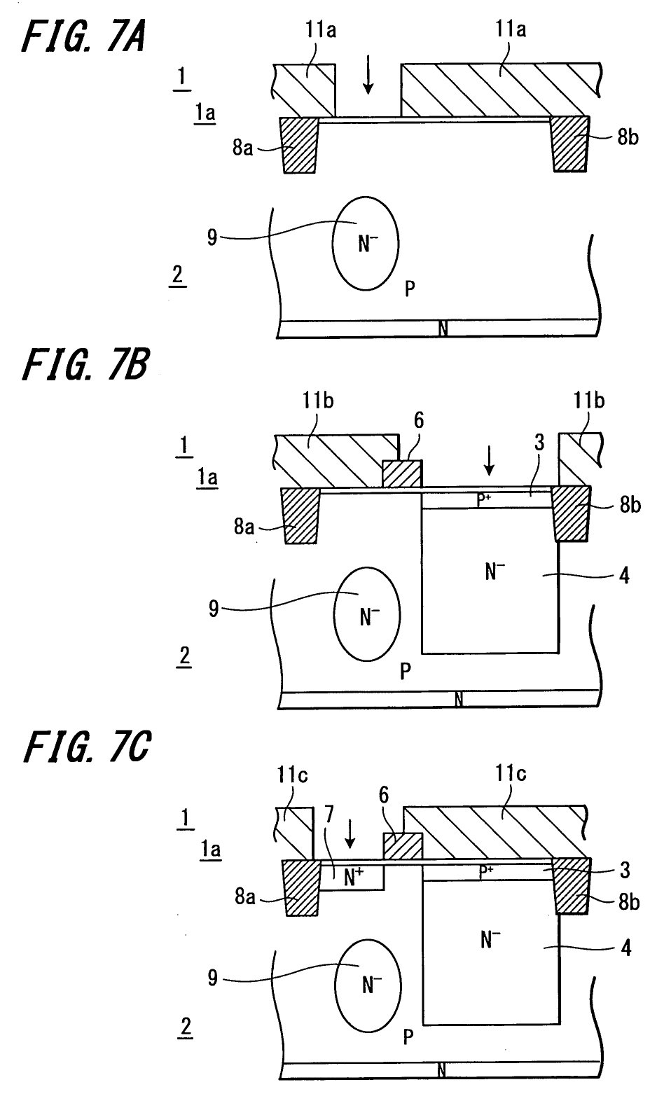

Here, an example of a method of manufacturing a solid-state imaging device according to the embodiment of the present invention will be described with reference to FIGS. 7A to 7C, in which the aforementioned second arrangement is used as an example.

In the method of manufacturing a solid-state imaging device according to the embodiment of the present invention, first, the N-type semiconductor substrate 2 is prepared and the element isolators 8a and 8b are formed on the substrate 2 at the position in which elements are to be isolated within the pixel and between the pixels. The depth of these element isolators 8a and 8b can be selected in a range of from 0.3 μm to 0.5 μm.

Subsequently, a P-type well region may be formed by implanting ions from the upper surface of the substrate 2 to a position having a predetermined depth to supply impurities such as boron (B) and boron difluoride (BF₂).

Subsequently, as shown in FIG. 7A, a resist 11a with an opening corresponding to the horizontal position of the finally obtained independent N-type region is formed and the independent N-type region 9 is formed by implanting ions through the opening of the resist 11a to supply impurities such as arsenic (As) and phosphorous (P). It is preferable that the independent N-type region 9 should be formed at a position deeper than the drain of a transfer transistor, which will be formed later, with a distance larger than 0.2 μm.

Subsequently, as shown in FIG. 7B, a gate 6 which finally forms a transfer transistor is formed by CVD (chemical vapor deposition). The gate 6 can be formed with a polycrystalline silicon film of 0.2 μm in thickness, for example.

Subsequently, a resist 11b having an opening formed at the position corresponding to the photodiode is formed, and the N-type region 4 and the P-type region 3 with a high concentration which form the photodiode are formed by implanting ions through the opening of the resist 11b. The photodiode should preferably be formed to have a depth deeper than the drain of a transfer transistor which will be formed later.

Subsequently, as shown in FIG. 7C, a resist 11c having an opening corresponding to the N-type region 7 with the high concentration that becomes the drain of a transfer transistor using the N-type region 4 as the source thereof is formed, and the highly-concentrated N-type region 7 is formed through the opening of the resist 11c.

It should be noted that, when the independent N-type region and the drain of the pixel transistor (transfer transistor) are formed, the areas of the openings of the resists 11a and 11c should preferably be selected to be approximately 30% to 40% of the pixel cell unit. On the other hand, when the photodiode is formed, the area of the opening of the resist 11b should preferably be selected to be approximately 60% to 70% of the pixel cell unit.

As described above, the solid-state imaging device 1 is obtained.

As is described in the above-mentioned embodiments and examples, according to embodiments of the solid-state imaging device and electronic device of the present invention, the independent first conductivity-type regions are continuously provided between adjacent pixels and nonuniformly provided within each pixel in the solid-state imaging device. Accordingly, it becomes possible to improve desired characteristics by selecting electric potential given to the independent first conductivity-type region while substrate potential dependence and decrease of the aperture ratio are being suppressed.

Specifically, according to the solid-state imaging device of the embodiments of the present invention, the solid-state imaging device includes the independent N-type region 9 independently of the N-type impurity region 7 which forms the amplifying circuit portion and the N-type impurity region 4 which forms the photoelectric-converting portion. Accordingly, independent electric potential can be set to the independent N-type region 9. If electric potential is set to the independent N-type region 9 together with selection of impurity concentrations in the N-type impurity region 7 and the N-type impurity region 4, then it becomes possible to improve desired characteristics such as electronic shutter operation characteristics, overflow path and suppression of blooming.

It is preferable that impurity concentrations should be selected in consideration of isolation of the independent N-type region from the N-type drain of the pixel transistor and the N-type photodiode. Specifically, impurity concentrations of the P-type regions should be selected in consideration of electric characteristics of the pixel transistor and those of the photodiode (or peripheral transistor). Accordingly, it is preferable that the impurity concentrations should be selected in consideration of a relationship with the independent N-type region and also a relationship with all these N-type regions.

The following points are mentioned as specific examples to be considered. First, when the independent N-type region is provided in the P-type region having a uniform concentration, there may be a case in which a potential barrier between the independent N-type region and the photodiode is approximately equal to a potential barrier between the independent N-type region and the drain of the pixel transistor. In such a case, there remains undetermined (random) portions in which electrons that overflow from the photodiode move to the drain of the pixel transistor or move to the independent N-type region. Therefore, the following arrangements or the like may be provided as more useful arrangements. Accordingly, there may be provided an arrangement to cause the independent N-type region and the N-type impurity region of the photodiode to be close to each other (that is, to lower a potential barrier between the independent N-type region and the photodiode). Further, there may be provided an arrangement to cause the pixel transistor and the independent N-type region to be distant from each other. Furthermore, there may be provided an arrangement to introduce N-type impurities with an ultra-low concentration (implanting ions of N-type impurities) into a space between the photodiode and the independent N-type region.

Further, in particular, according to the solid-state imaging device of the embodiment of the present invention, since the photodiode can start accumulating electrons immediately after transferring the electrons to the floating diffusion, operation speeds and efficiency can be improved.

According to the solid-state imaging device of the embodiments of the present invention, since such improvement of operations can be obtained in bulk, an aperture ratio can be controlled so as not to be lowered. According to the related-art arrangement, a reset transistor is separately provided to a photodiode to reset the photodiode so as to discharge electrons at a predetermined potential before overflowing, thereby enlarging the dynamic range by integrating the results. According to the related-art arrangement, however, an area to separately form wiring within the pixel may be necessary, which is disadvantageous from a standpoint of an aperture ratio.

According to the arrangement of the embodiments of the present invention, since another wiring may not be separately required in order to improve characteristics, the area of the amplifying circuit portion can be prevented from increasing (that is, the aperture ratio of the photodiode can be prevented from being lowered) while characteristics are improved. Accordingly, it becomes possible to provide the arrangement capable of carrying out the reset operation of the photodiode independently of the floating diffusion without sacrificing the aperture ratio.

Also, according to an embodiment of the solid-state imaging device of the present invention, it may be possible for the CMOS image sensor to obtain such operations and structures as single reset operation of photodiode, overflow drain and suppression of blooming, which are known as features of a CCD (charge-coupled device). It is known that, if the CCD is provided with an ordinary lateral overflow drain, the area for the overflow should be secured near the surface of the pixel with the result that the aperture ratio is lowered. Although several proposals have been made in order to suppress blooming by improving the lateral overflow drain, such overflow drain may require an area in the lateral direction and it is difficult not to lower the aperture ratio. Also, in a vertical overflow drain adopted by the CCD, since it may be necessary to greatly change the substrate potential, power consumption is large. Further, in CMOS image sensors in which logic circuits are provided within the same chip in a mixed state, there is a risk that the vertical overflow drain will exert influences upon the circuits. Hence, the vertical overflow drain may not be a realistic solution. According to the solid-state imaging device of the embodiments of the present invention, in addition to the fact that it may suppress blooming to a certain level or less, it becomes possible to avoid the aforementioned problems (decrease of aperture ratio, increase of power consumption and influence exerted upon circuits).

It should be noted that materials and the amount and numerical conditions of treatment times and dimensions described in the above embodiments of the present invention may be preferred examples. Also, dimensions, shapes and arrangement relationships in the figures used to explain embodiments of the present invention are schematic conditions. In other words, the present invention is not limited to those embodiments of the present invention.

For example, while the first conductivity-type is set to N-type and the second conductivity-type is set to P-type in the aforementioned embodiments of the present invention, both of them may be set to opposite conductivity types.

Also, according to the above-described embodiments, the independent first conductivity-type regions are not provided to the whole area but are provided partly including the width (provided discontinuously in the second direction), as an example in which the independent first conductivity-type regions are provided nonuniformly. However, the independent first conductivity-type regions may be provided over the whole area of the pixel as long as they are non-uniform within each pixel. As such example, there may be an arrangement in which the independent first conductivity-type regions are particularly increased in thickness only at the position in which the independent first conductivity-type regions are provided (immediately below the photodiode) in the aforementioned first example of the arrangement. Here, the independent first conductivity-type regions also become continuous between adjacent pixels not only in the first direction within the two-dimensional plane but also in the second direction so that wider range in the pixel array can be covered. According to the above-mentioned arrangement, all pixels become able to operate in predetermined manners at the same time without distinguishing a plurality of pixels extending in the aforementioned second direction, for example.

Also, each pixel may have two or more independent N-type regions, for example. For example, there may be obtained an arrangement in which independent N-type region may be provided at the depth position different from that of the photodiode and the independent N-type region may be provided at the side of the photodiode, that is, two independent N-type regions may be provided. In the case of the arrangement, the independent N-type region can share improvements of characteristics such as the aforementioned electronic shutter, overflow path and suppression of blooming and the aperture ratio of the photodiode can be improved by replacing wiring, which was not buried in the related-art, with one independent N-type region.

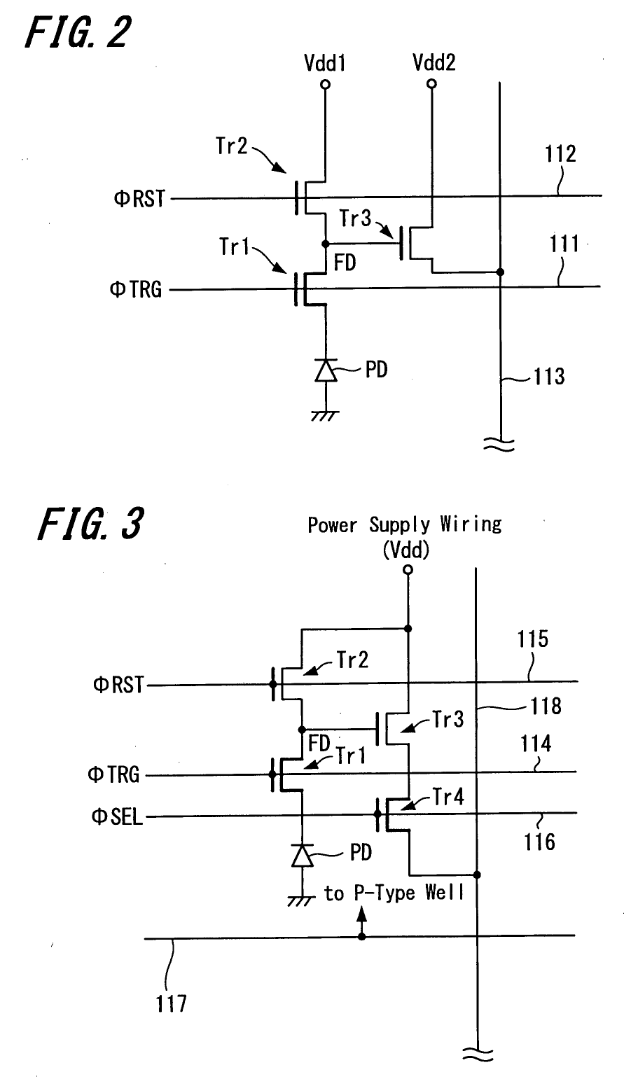

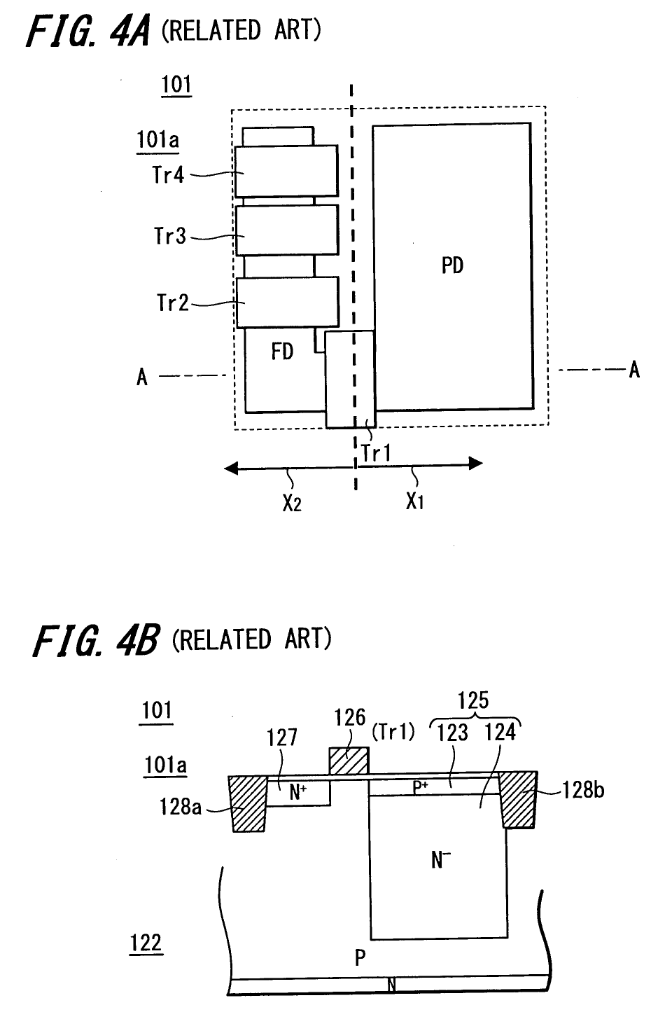

Further, the aforementioned embodiments of the present invention have been described so far with reference to the case in which the amplifying circuit portion includes the four-transistor type pixel circuit arrangement shown in FIG. 3. However, the pixel circuit arrangement is not limited to the above-mentioned four-transistor type pixel arrangement, but it may be other arrangements formed of a plurality of transistors such as the 3-transistor type pixel circuit arrangement shown in FIG. 2. In addition, an embodiment of the present invention can be variously modified and changed, such that the solid-state imaging device according to an embodiment of the present invention may be an element formed as one chip or formed of a plurality of chips, or may be formed as a module.

It should be understood by those skilled in the art that various modifications, combinations, sub-combinations and alterations may occur depending on design requirements and other factors insofar as they are within the scope of the appended claims or the equivalents thereof.

What is claimed is:

1. A solid-state imaging device comprising:
an imaging area including a plurality of pixels arrayed in a two-dimensional matrix, each of the pixels including a photodiode having a first conductivity-type electric charge accumulation area and a transistor for reading electric charges obtained at the photodiode; and
an independent first conductivity-type region provided at least to part of the plurality of pixels and isolated from the photodiode and the transistor, wherein
the independent first conductivity-type region is provided continuously between adjacent pixels and nonuniformly within each pixel.

2. A solid-state imaging device according to claim 1, wherein
the independent first conductivity-type region is formed as a region having a position different from that of the photodiode in a depth direction perpendicular to the two-dimensional plane.

3. A solid-state imaging device according to claim 1, wherein
the independent first conductivity-type region is formed as a region having a position common to that of the photodiode in the depth direction perpendicular to the two-dimensional plane.

4. A solid-state imaging device according to claim 1, wherein
the independent first conductivity-type region is formed as a continuous region between adjacent pixels in a first direction and formed as a discontinuous region between adjacent pixels in a second direction in the two-dimensional plane.

5. A solid-state imaging device according to claim 1, wherein
the independent first conductivity-type region is isolated from the photodiode and the transistor through a second conductivity-type region.

6. An electronic device including a solid-state imaging device, the solid-state imaging device comprising:
an imaging area including a plurality of pixels arrayed in a two-dimensional matrix, each of the pixels including a photodiode having a first conductivity-type electric charge accumulation area and a transistor for reading electric charges obtained at the photodiode; and
an independent first conductivity-type region provided at least to part of the plurality of pixels and isolated from the photodiode and the transistor, wherein
the independent first conductivity-type region is provided continuously between adjacent pixels and nonuniformly within each pixel.
